(19) United States
(12) Patent Application Publication
(10) Pub. No.: US 2012/0064223 A1
(43) Pub. Date: Mar. 15, 2012

(54) Drug Coated Balloon Surface Relaxation Process To Minimize Drug Loss

(75) Inventors: Jose Gamez, Menlo Park, CA (US); John Stankus, Campbell, CA (US); Stephen D. Pacetti, San Jose, CA (US); Victoria M. Gong, Sunnyvale, CA (US); Benjamyn Serna, Gilroy, CA (US); Binh Nguyen, Newark, CA (US)

(73) Assignee: ABBOTT LABORATORIES, Santa Clara, CA (US)

(21) Appl. No.: 12/882,990

(22) Filed: Sep. 15, 2010

(51) Int. Cl. B05D 5/00; B05C 13/02; B05C 11/00; B05D 3/00

(52) U.S. Cl. 427/2.3; 118/58

(57) ABSTRACT

Method of coating an expandable member is provided. The method comprises providing an expandable member having deflated and fully expanded configurations, and inflating the expandable member with a select amount of inflation medium, the select amount of inflation medium applied at a nominal pressure, disposing a therapeutic agent on at least a portion of the expandable member; and partially deflating the expandable member, wherein partially deflating includes releasing an initial amount of inflation medium from the expandable member such that the expandable member partially re-folds. The therapeutic agent can be dried on the expandable member, and a remaining amount of inflation medium can be withdrawn such that the expandable member resumes the completely folded configuration.

### BACKGROUND OF THE DISCLOSED SUBJECT MATTER

1. Field of the Disclosed Subject Matter

The presently disclosed subject matter is related to coating interventional medical devices, and particularly coating of therapeutic agents on an expandable member of a medical device. More particularly, the presently disclosed subject matter relates to a system and method for retaining a therapeutic agent on a balloon during processing and delivery of the medical device.

2. Description of related Subject Matter

Atherosclerosis is a disease affecting arterial blood vessels. It is a chronic inflammatory response in the walls of arteries, which is in large part due to the accumulation of lipid, macrophages, foam cells and the formation of plaque in the arterial wall. Atherosclerosis is commonly referred to as hardening of the arteries, although the pathophysiology of the disease manifests itself with several different types of lesions ranging from fibrotic to lipid laden to calcific. Angioplasty is a vascular interventional technique involving mechanically widening an obstructed blood vessel, typically caused by atherosclerosis.

During angioplasty, a catheter having a folded balloon is inserted into the vasculature of the patient and is passed to the narrowed location of the blood vessel at which point the balloon is inflated to a fixed size as a result of fluid pressure inside the balloon. Percutaneous coronary intervention (PCI), commonly known as coronary angioplasty, is a therapeutic procedure to treat the stenotic coronary arteries of the heart, often found in coronary heart disease. In contrast, peripheral angioplasty, commonly known as percutaneous transluminal angioplasty (PTA), generally refers to mechanical widening of blood vessels other than the coronary arteries. PTA is most commonly used to treat narrowing of the leg arteries, especially, the iliac, external iliac, superficial femoral and popliteal arteries. PTA can also treat narrowing of veins, and other blood vessels.

Although the blood vessel is often successfully widened by angioplasty, sometimes the treated wall of the blood vessel undergoes vasospasm, or abrupt closure after balloon inflation or dilatation, causing the blood vessel to collapse after the balloon is deflated or shortly thereafter. One solution to this abrupt closure is stenting the blood vessel to prevent collapse. A stent is a device, typically a metal tube or scaffold, that is inserted into the blood vessel after, or concurrently with angioplasty, to hold the blood vessel open.

While the advent of stents eliminated many of the complications of abrupt vessel closure after angioplasty procedures, within about six months of stenting, a re-narrowing of the blood vessel can form. This is a condition known as restenosis. Restenosis was discovered to be a response to the injury of the angioplasty procedure and is characterized by a growth of smooth muscle cells—analogous to a scar forming over an injury. To address this condition, drug eluting stents were developed to reduce to the reoccurrence of the narrowing of blood vessels after stent implantation. A drug eluting stent is a metal stent that has been coated with a drug that is known to interfere with the process of re-narrowing of the blood vessel (restenosis). Examples of various known drug eluting stents are disclosed in U.S. Pat. Nos. 5,649,977; 5,464,650; 5,591,227, 7,378,105; 7,445,792; 7,335,227, each of which are hereby incorporated by reference in their entirety. However, a drawback of drug eluting stents is a condition known as late stent thrombosis, which is an event in which blood clots on the stent.

Drug eluting balloons are believed to be a viable alternative to drug eluting stents in the treatment of atherosclerosis. In a study which evaluated restenosis, and the rate of major adverse cardiac events such as heart attack, bypass, repeat stenosis, or death in patients treated with drug eluting balloons and drug eluting stents, the patients treated with drug eluting balloons experienced only 3.7% restenosis and 4.8% MACE (major adverse cardiac events) as compared to patients treated with drug eluting stents, in which restenosis was 20.8% and 22.0% MACE rate. (See, PEPCAD II study, Rotenburg, Germany)

However, drug eluting balloons present certain unique challenges. For example, the drug carried by the balloon needs to remain on the balloon during delivery to the lesion site, and released from the balloon surface to the blood vessel wall when the balloon is expanded at the lesion site. For coronary procedures, the balloon is typically inflated for less than one minute, typically about thirty seconds. The balloon can be expanded for a longer period of time for peripheral procedures although this time rarely exceeds 5 minutes. Due to the short duration of contact of the drug coated balloon surface with the blood vessel wall, the balloon coating must exhibit efficient therapeutic agent transfer and/or efficient drug release during inflation. Thus, there are challenges specific to drug delivery via a drug coated or drug eluting balloon that are not presented by a drug eluting stent.

Conventional methods of loading interventional devices with therapeutic agents often require coating the entire surface of the balloon with the therapeutic agent. Coating of the entire surface can be performed in the inflated condition. For purpose of storage and shipping, as well as delivery through vasculature, the balloon is folded when deflated. However, once coated with a therapeutic agent, the balloon can become difficult to fold and sheath for assembly of the catheter. Further, conventional equipment and processes used to achieve such folding and assembly often cause damage, loss, or contamination of the therapeutic agent, and/or can result in contamination of the equipment. For example, conventional techniques for coating and folding the balloon require that the balloon be coated and subsequently dried in an expanded condition and thereafter collapsed into the completely folded configuration. This folding operation can cause fragmentation of the dried coating which can dislodge from the balloon surface, and/or cracking which effectively increases the surface area of the coating in contact with blood during delivery. Consequently, conventional coating and folding techniques can result in a drug loss of between 10%-60% of the target dose.

Alternatively, balloons can be coated with a therapeutic agent while in a folded condition, thereby avoiding the drawbacks listed above. However, applying a coating of a solution to a folded balloon results in only a partially coated balloon surface area which may not be desirable depending upon the needs and application. Furthermore, the entire surface area of a coating applied to the folded balloon is exposed to the blood stream during the tracking and delivery procedure, thus increasing the likelihood of losing a significant amount, if not all, of the drug coating before positioning the balloon and therapeutic agent at the desired location to commence treatment.

Thus there remains a need, and an aim of the disclosed subject matter is directed towards, a method with corresponding apparatus for assembly of an expandable member having one or more therapeutic agents coated thereon in such a manner that does not result in damage or loss of therapeutic agent, during processing or delivery of the medical device.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a system and method for assembly of an expandable member having one or more therapeutic agents coated thereon in such a manner that does not result in damage or loss of therapeutic agent, nor significant contamination of the equipment employed.

In accordance with an aspect of the disclosed subject matter, a method of coating an expandable member is provided. The method includes a method of coating an expandable member comprising providing an expandable member having a fully deflated and fully expanded configuration at a nominal pressure, inflating the expandable member to an initial pressure of from about 10% to about 300% of the nominal pressure and disposing a therapeutic agent on at least a portion of the expandable member at the initial pressure. The initial pressure is preferably from about 20% to about 100% of nominal pressure, and in one embodiment in accordance with this disclosure, is from about 20% to about 40% of nominal pressure. In another embodiment, the nominal pressure is from about 6 to about 12 atmospheres. Further, the expandable member is partially deflated to an intermediate pressure of from about 1% to about 100% of nominal pressure. The preferred intermediate deflation pressure is from about 10% to about 50% of nominal pressure, and in one embodiment in accordance with this disclosure, is from about 10% to about 20% of nominal pressure. Additionally, the therapeutic agent on the expandable member can be dried, e.g. by exposing the expandable member to an air stream of variable temperature and flow rate.

In one embodiment, the intermediate pressure is equal to the initial pressure. Additionally, the initial pressure can inflate the expandable member to less than the fully expanded configuration. The therapeutic agent includes a mixture of at least one excipient and at least one solvent, and furthermore can be heated to remove the solvent after coating, if so desired.

The pressure can be varied to control the rate of inflation or deflation of the expandable member. In some embodiments, deflating the expandable member includes applying a negative pressure to reach the intermediate pressure. Alternatively, deflating the expandable member can include exposing the expandable member to ambient conditions to reach the intermediate pressure.

After partially deflating the expandable member, the remaining pressure can be withdrawn from the expandable member by drawing a vacuum on the expandable member. Additionally, the therapeutic agent can be exposed to a plasticizing atmosphere when the expandable member is in the inflated condition.

Various coating techniques can be employed, including spraying, dipping, syringe coating, electrospinning, electrostatic coating, direct coating, or a combination thereof. The expandable member can include a plurality of folds defined therein, and have a folded configuration when deflated. A mandrel can be inserted within a lumen of the expandable member during coating and/or drying of the coating on the expandable member.

Additionally, the disclosed subject matter includes a system for coating an expandable member having a plurality of folds defined therein, the system comprising an inflator to inflate an expandable member to an initial pressure of from about 10% to about 300% of nominal pressure, and a dispenser to dispose a therapeutic agent on at least a portion of an expandable member at the initial pressure. A deflation station is provided to partially deflate an expandable member by reducing the pressure within the expandable member to an intermediate pressure of from about 1% to about 100% of nominal pressure. A drying station is also included to dry the therapeutic agent on the expandable member. Additionally, the initial inflation pressure inflates the expandable member to less than its fully expanded configuration. The system can further include a mandrel within a lumen of the expandable member.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

FIG. 1 is a schematic representation of an expandable member catheter in accordance with the disclosed subject matter.

FIG. 1A is a schematic cross-sectional view taken along lines A-A in FIG. 1.

FIG. 1B is a schematic cross-sectional view taken along lines B-B in FIG. 1.

FIG. 2 is flow chart of the method in accordance with the disclosed subject matter.

FIG. 3 is a schematic axial view of an expandable member which is coated and dried in the expanded configuration.

FIG. 4 is a schematic axial view of an expandable member which is coated in an expanded configuration and partially refolded prior to drying in accordance with the disclosed subject matter.

### DETAILED DESCRIPTION OF THE PREFERRED EMBODIMENT

Reference will now be made in detail to the preferred embodiments of the disclosed subject matter, examples of which are illustrated in the accompanying drawings. The method and corresponding steps of the disclosed subject matter will be described in conjunction with the detailed description of the system.

The methods and systems presented herein can be used for manufacture and assembly of medical devices such as a drug coated balloon catheter having an expandable member with a reduced profile, i.e. collapsed, and a fully expanded configuration. In some embodiments, the expandable member can be configured with a plurality of folds defined therein. Accordingly, the reduced profile, i.e. collapsed configuration of such expandable members coincides with the folded condition.

The disclosed subject matter is particularly suited for coating and retaining a therapeutic agent on a folded expandable member of a medical device, without damage to the coating, during folding of the expandable member, as well as assembly and delivery of the medical device. While the disclosed subject matter references application of a fluid, e.g. therapeutic agent, it is to be understood that a variety of coatings including polymeric, therapeutic, or matrix coatings, can be applied to various surfaces of medical devices, as so desired. The expandable member can be folded at suitable conditions to maintain the plurality of folds defined therein.

In accordance with the disclosed subject matter, a method of coating and folding an expandable member is provided. The method includes providing an expandable member, which can be configured with a plurality of folds defined therein. The expandable member has a folded configuration and a fully expanded configuration at a nominal pressure. The potential pressure applied to the expandable member can range from about 1 to about 24 atm with a nominal pressure of from about 6 to about 12 atm. The expandable member is inflated with an initial inflation pressure of from about 10% to about 300% of nominal pressure, and a coating is disposed on at least a portion of the expandable member. The initial pressure is preferably from about 20% to about 100% of nominal pressure, and in one embodiment in accordance with this disclosure, is from about 20% to about 40% of nominal pressure. The expandable member is then partially deflated by releasing a predetermined amount of inflation medium from the expandable member to reduce the pressure within the expandable member from the initial inflation pressure to an intermediate pressure. The therapeutic agent is dried on the surface of the expandable member while in this partially folded configuration.

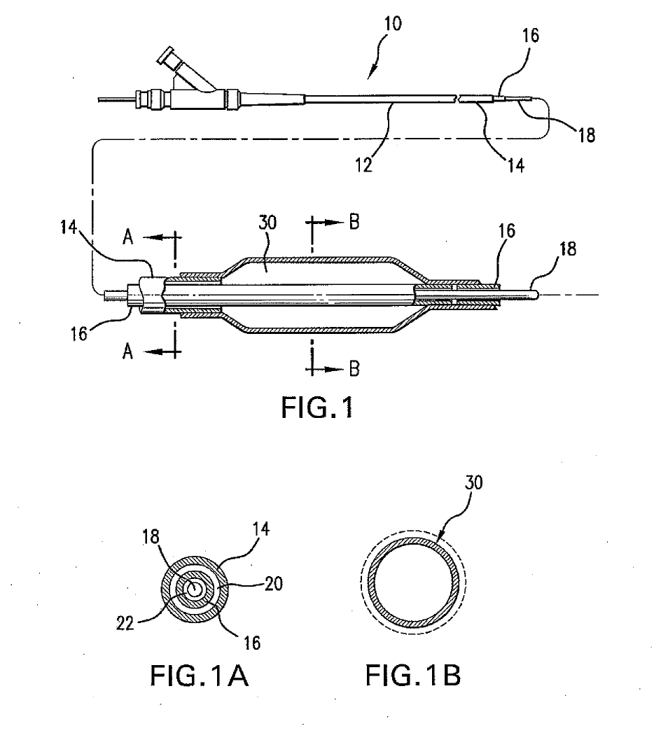

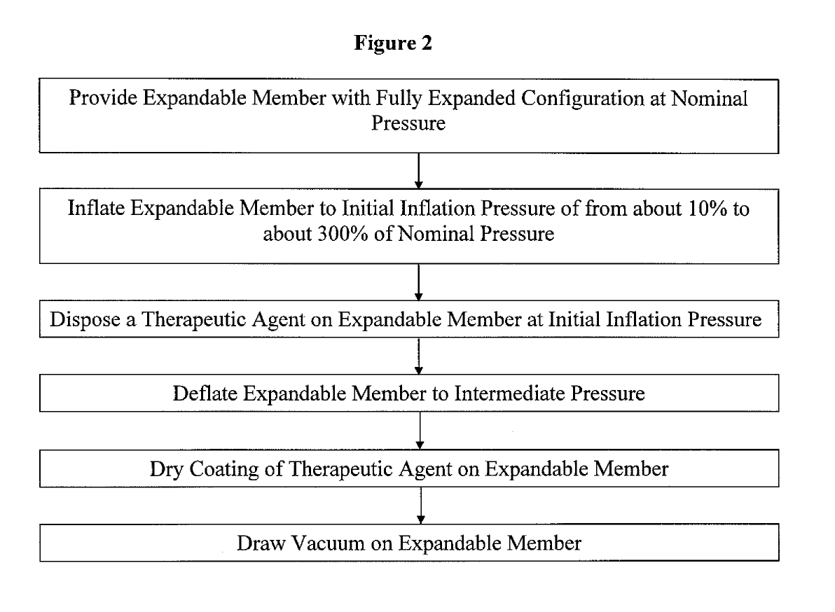

For purpose of explanation and illustration, and not limitation an exemplary embodiment of a medical device having an expandable member is shown schematically in FIGS. 1A-B. Particularly, and as illustrated, the medical device embodied herein is a balloon catheter 10, which includes an elongated catheter shaft 12 having a proximal end and having a distal end and an expandable member 30 located proximate the distal end of the catheter shaft. The expandable member, or balloon as depicted herein, has an outer surface and an inner surface disposed at the distal end portion of the catheter shaft, as shown in FIGS. 1 and 1B. In accordance with the disclosed subject matter, a coating is applied to at least a portion of the outer surface of the balloon.

The elongated catheter shaft 12 comprises an outer tubular member 14 and an inner tubular member 16. The outer tubular member 14 defines an inflation lumen 20 disposed between the proximal end portion and the distal end portion of the catheter shaft 12. Specifically, as illustrated in FIG. 1A, the coaxial relationship of this representative embodiment defines an annular inflation lumen 20 between the inner tubular member 16 and the outer tubular member 14. The expandable member 30 is in fluid communication with the inflation lumen 20. The inflation lumen can supply an inflation medium under positive pressure and can withdraw the inflation medium, i.e. provide negative pressure, from the expandable member. The expandable member 30 can thus be inflated and deflated. The elongated catheter is sized and configured for delivery through a tortuous anatomy, and can further include a guidewire lumen 22 that permits it to be delivered over a guidewire 18. As illustrated in FIG. 1A, the inner tubular member 16 defines the guidewire lumen 22 for the guidewire 18. Although FIGS. 1 and 1b illustrate the guidewire lumen as having a coaxial over-the-wire (OTW) construction, the guidewire lumen can be configured as dual lumen over-the-wire (OTW) or a rapid-exchange (RX) construction, as is well known in the art.

A wide variety of balloon catheters and balloon constructs are known and suitable for use in accordance with the disclosed subject matter. For example, the expandable member can be made from polymeric material such as compliant, non-compliant or semi-compliant polymeric material or polymeric blends. Examples of such suitable materials include, but are not limited to, nylon 12, nylon 11, nylon 9, nylon 6, nylon 6/12, nylon 6/11, nylon 6/9, and nylon 6/6, polyurethane, silicone-polyurethane. Examples of other balloon and catheter embodiments which can be employed in accordance with the disclosed subject matter include U.S. Pat. Nos. 4,748,982; 5,496,346; 5,626,600; 5,300,085, 6,406,457 and application Ser. Nos. 12/371,426; 11/539,944; 12/371,422, each of which is hereby incorporated by reference in their entirety.

In accordance with the disclosed subject matter, any of a variety of fluid compositions can be applied to the expandable member. For example, the fluid can include a therapeutic agent for treatment of tissue. Examples of suitable therapeutic agents include anti-restenosis, pro- or anti-proliferative, anti-inflammatory, antineoplastic, antiplatelet, anti-mitotic, anti-coagulant, anti-fibrin, cytostatic, cytoprotective, ACE inhibiting, cardioprotective, antithrombotic, antimitotic, antibiotic, antiallergic and antioxidant compounds. Such therapeutic agents can be, again without limitation, a synthetic inorganic or organic compound, a protein, a peptide, a polysaccharides and other sugars, a lipid, DNA and RNA nucleic acid sequences, an antisense oligonucleotide, an antibodies, a receptor ligands, an enzyme, an adhesion peptide, a blood clot agent including streptokinase and tissue plasminogen activator, an antigen, a hormone, a growth factor, a ribozyme, and a retroviral vector. Preferably, however, the therapeutic agents include, cytostatic drug. The term “cytostatic” as used herein means a drug that mitigates cell proliferation but allows cell migration. These cytostatic drugs, include for the purpose of illustration and without limitation, macrolide antibiotics, rapamycin, everolimus, zotarolimus, biolimus A9, deforolimus, AP23572, myolimus, novolimus, tacrolimus, temsirolimus, pimecrolimus, structural derivatives and functional analogues of rapamycin, structural derivatives and functional analogues of everolimus, structural derivatives and functional analogues of zotarolimus and any macrolide immunosuppressive drugs. The term “antiproliferative” as used herein means a drug used to inhibit cell growth, such as chemotherapeutic drugs. Some non-limiting examples of antiproliferative drugs include taxanes, paclitaxel, and protaxel.

Examples of anti-inflammatory drugs include both steroidal and non-steroidal (NSAID) anti-inflammatories such as, without limitation, clobetasol, alclofenac, alclometasone dipropionate, algestone acetonide, alpha amylase, amcinafal, amcinafide, amfenac sodium, amiprilose hydrochloride, anakinra, anirolac, anitrazafen, apazone, balsalazide disodium, bendazac, benoxaprofen, benzydamine hydrochloride, bromelains, broperamole, budesonide, carprofen, cicloprofen, cintazone, cliprofen, clobetasol propionate, clobetasone butyrate, clopirac, cloticasone propionate, cormethasone acetate, cortodoxone, deflazacort, desonide, desoximetasone, dexamethasone, dexamethasone dipropionate, dexamethasone acetate, dexmethasone phosphate, momentasone, cortisone, cortisone acetate, hydrocortisone, prednisone, prednisone acetate, betamethasone, betamethasone acetate, diclofenac potassium, diclofenac sodium, diflorasone diacetate, diflumidone sodium, diflunisal, difluprednate, diftalone, dimethyl sulfoxide, drocinonide, endrysone, enlimomab, enolicam sodium, epirizole, etodolac, etofenamate, felbinac, fenamole, fenbufen, fenclofenac, fenclorac, fendosal, fenpipalone, fentiazac, flazalone, fluazacort, flufenamic acid, flumizole, flunisolide acetate, flunixin, flunixin meglumine, fluocortin butyl, fluorometholone acetate, fluquazone, flurbiprofen, fluretofen, fluticasone propionate, furaprofen, furobufen, halcinonide, halobetasol propionate, halopredone acetate, ibufenac, ibuprofen, ibuprofen aluminum, ibuprofen piconol, ilonidap, indomethacin, indomethacin sodium, indoprofen, indoxole, intrazole, isoflupredone acetate, isoxepac, isoxicam, ketoprofen, lofemizole hydrochloride, lomoxicam, loteprednol etabonate, meclofenamate sodium, meclofenamic acid, meclorisone dibutyrate, mefenamic acid, mesalamine, meseclazone, methylprednisolone suleptanate, momiflumate, nabumetone, naproxen, naproxen sodium, naproxol, nimazone, olsalazine sodium, orgotein, orpanoxin, oxaprozin, oxyphenbutazone, paranyline hydrochloride, pentosan polysulfate sodium, phenbutazone sodium glycerate, pirfenidone, piroxicam, piroxicam cinnamate, piroxicam olamine, pirprofen, prednazate, prifelone, prodolic acid, proquazone, proxazole, proxazole citrate, rimexolone, romazarit, salcolex, salnacedin, salsalate, sanguinarium chloride, seclazone, sermetacin, sudoxicam, sulindac, suprofen, talmetacin, talniflumate, talosalate, tebufelone, tenidap, tenidap sodium, tenoxicam, tesicam, tesimide, tetrydamine, tiopinac, tixocortol pivalate, tolmetin, tolmetin sodium, triclonide, triflumidate, zidometacin, zomepirac sodium, aspirin (acetylsalicylic acid), salicylic acid, corticosteroids, glucocorticoids, tacrolimus and pimecrolimus.

Additionally or alternatively, the fluid can include other compounds or additives, such as excipients, binding agents, plasticizers, solvents, surfactants, additives, fillers, and the like. Examples of possible compounds include polyvinylpyrrolidone, gelatin, maltrodextrin, starch, hydroxypropyl methyl cellulose, glycerol, polyethylene glycol, polysorbates, tweens, polyoxamers, Vitamin E TPGS, fatty alcohols, fatty esters, tocopherols, and phospholipids. In one embodiment the therapeutic agent can be provided in liquid form or dissolved in a suitable solvent. In another embodiment, therapeutic agent is provided as a particulate and mixed in a suitable carrier for application as a fluid.

In accordance with the disclosed subject matter, the expandable member of the medical device has a plurality of folds defined therein, however the disclosed subject matter includes expandable members without folds, as discussed above. For example, a number of conventional balloon catheters include such folds, so as to have a folded configuration and a fully expanded configuration. Generally, the formation of folds can be performed using heat and pressure to form or define creases in the material of the balloon. Examples of such folded balloons are disclosed, for purpose of illustration in U.S. Pat. Nos. 6,494,906; 6,478,807; 5,911,452, each of which is hereby incorporated by reference in their entirety.

Particularly, a plurality of folds or pleats are initially imparted into a expandable member of a catheter by any means known in the art. This is accomplished by processing the expandable member in a pleat head that imparts a plurality of folds or pleats into the expandable member. After this, the pleated expandable member is processed in a fold head where the pleats are wrapped in on direction and compressed to reduce the overall profile. In one embodiment, five folds of equivalent surface area are imparted into the expandable member which result in a symmetrical shape when in the folded, i.e. uninflated, configuration. Although the exemplary embodiment illustrated in the drawings depicts five folds, it is to be understood that the number and size of the folds can vary, as so desired, to expandable members of various dimensions and shapes. In another embodiment, four folds of equivalent surface area are imparted into the expandable member. The folded configuration provides a reduced profile which facilitates assembly, storage and shipping of the catheter. Additionally, the reduced profile of the folded expandable member improves the deliverability and trackability of the catheter through the vascular anatomy.

In one embodiment, a Machine Solutions Inc. (MSI) Pleat and Fold Machine or equivalent can be used to pleat and fold the expandable member. The MSI Pleat and Fold machine pleats the expandable member at an elevated temperature (above Tg of the polymer) for a brief dwell time (10-30 s). The expandable member is then allowed to cool back to room temperature. A sheath is then placed over the expandable member to hold the folds in place.

With the desired number of folds imparted in the expandable member, the expandable member is inflated at a nominal pressure and fluid such as a therapeutic agent is disposed thereon. To assist with the application of the therapeutic agent on the surface of the expandable member, a mandrel can be inserted within the guidewire lumen 22. The mandrel can be constructed from a variety of materials, e.g. metal, metal alloys, and polymeric materials having sufficient rigidity to maintain the catheter in a linear alignment. In this regard, the mandrel serves to inhibit or prevent bowing or warping of the catheter and expandable member. Accordingly, the expandable member is maintained in a consistent and linear alignment about the longitudinal axis of the catheter, which in turn can allow for a uniform coating of therapeutic agent along the desired length of the expandable member. Furthermore, maintaining the expandable member in a fixed profile and linear alignment can assist in minimizing waste of therapeutic agent during the coating process, e.g., spraying, dipping, direct fluid coating, etc. If coating is to be performed on an assembled catheter, the mandrel can have a length to extend the entire length of the catheter and an outer diameter sized to be positioned within the guidewire lumen 22.

One or more coatings can be applied to the select portions of the medical device by processes such as spraying, dipping, syringe coating, electrospinning, electrostatic coating, direct coating, direct fluid application as disclosed in Application Ser. No. 61/345,575, combinations thereof, or other means as known to those skilled in the art. The coating can be applied over at least a portion or the entirety of the expandable member or medical device in non-uniform, or uniform concentrations and/or patterns. The coating characteristics can be affected by process variables. For example, for dip-coating process, coating quality and thickness can vary as an effect of variables such as number, rate, and depth of dips along with drying time and temperature. Accordingly, the variables of the particular coating process employed can be controlled to achieve the desired coating characteristics. By way of example, and not limitation, certain coating processes that can be used with the instant invention are described in U.S. Pat. No. 6,669,980 to Hansen; U.S. Pat. No. 7,241,344 to Worsham; and U.S. Publication No. 20040234748 to Stenzel, the disclosures of which are hereby incorporated by reference in their entirety.

In accordance with the disclosed subject matter, the expandable member is at least partially inflated, and in some embodiments fully inflated, when the fluid is disposed thereon. The extent in which the expandable member is inflated will depend at least in part on the amount, or pressure, of inflation medium selected for initial inflation. It therefore is preferable that the select inflation pressure be sufficient to expose the surfaces of the expandable member desired to be coated. Particularly, it is beneficial to apply the coating to a fully inflated expandable member since a fully inflated expandable member provides a larger surface area to which a coating can be applied, thus allowing for a greater amount and efficacy of coating. Although various fluids are suitable for use in accordance with the disclosed subject matter, it is advantageous to employ a gaseous medium (e.g. air, oxygen, nitrogen, etc.) to ensure that there is no film or residue retained on the interior walls of the expandable member which can adversely affect the refolding process and final weight of the expandable member. Preferably, the expandable member is inflated at an initial pressure which is a percentage of a nominal inflation pressure, such as from about 10% to about 50% of nominal pressure and preferably from about 10 to about 20% of nominal pressure, for a given balloon size/material. Inflation of the expandable member beyond this range can result in excess crack formation and deformities in the coating applied to the expandable member. By inflating to a pressure less than nominal while coating, re-folding is more easily achieved because the pleat/fold memory is maintained.

In accordance with an aspect of the disclosed subject matter, and in order to realize the benefits of the reduced profile expandable members described above, the initial inflation pressure is at least partially released or decreased to an intermediate pressure such that the expandable member is partially refolded after the desired coating is applied to the expandable member. To avoid detrimental impact to the applied coating during the refolding process, the expandable member is first partially deflated by releasing an initial amount, or pressure, of inflation medium. Particularly, a select amount of inflation fluid or pressure, which is less than the initial inflation pressure contained within the expandable member during the coating process, is released or reduced to an intermediate pressure. Consequently, the expandable member is partially deflated and partially refolded.

The release of the initial amount of fluid, or initial inflation pressure, can be performed by exposing the expandable member to ambient conditions. That is, the expandable member in its at least partially expanded configuration and initial inflation pressure will have an elevated pressure as compared to the ambient conditions. Accordingly, upon release of the initial amount of fluid, or initial inflation pressure, by exposure to the ambient conditions, the pressure differential will cause at least some of the initial amount of fluid contained within the expandable member to exit and reduce the pressure within the expandable member to an intermediate pressure. Thus, the expandable member will partially deflate and partially refold with minimal stress imparted on the coating disposed on the surface of the expandable member. The pressure release post coating of the expandable member should be performed within 10 s and preferably should be immediate.

To determine whether the drug retained on the expandable member meets the desired criteria, a visual inspection of the expandable member for any grossly missing drug should be performed. A drug content analysis by high performance liquid chromatography (HPLC) is then performed on the finished product. Additional inspection or testing can be performed using conventional analytics.

Additionally, or alternatively, a negative pressure can be drawn on the expandable member to reduce the pressure to an intermediate pressure and thus partially deflate the expandable member. In embodiments in which a negative pressure is applied to release the initial amount of fluid, or reduce the initial inflation pressure to the intermediate pressure, the negative pressure is less than the vacuum pressure required to withdraw the entire amount of fluid, or initial inflation pressure, in the expandable member and thus return the expandable member to the completely folded or collapsed condition. The pressure of the expandable member can be controlled to be independently optimized such that the rate of inflation and/or depressurization can be adjusted either continuously or via a step-wise function.

For purpose of withdrawing an initial amount of inflation medium and achieve an intermediate inflation pressure, a number of known techniques can be used. For example, and as embodied herein, a deflation device such as a syringe pump, having a gas-tight syringe can be attached to the inflation lumen of the expandable member and withdraw a volume of fluid. The deflation device allows for automated, repeatable, and controlled amount of fluid withdrawn by volume from the expandable member. This is advantageous since it reduces or eliminates the variability inherent in a human operator controlled method or apparatus. Alternative devices and techniques can be used for withdrawing desired amounts of inflation medium.

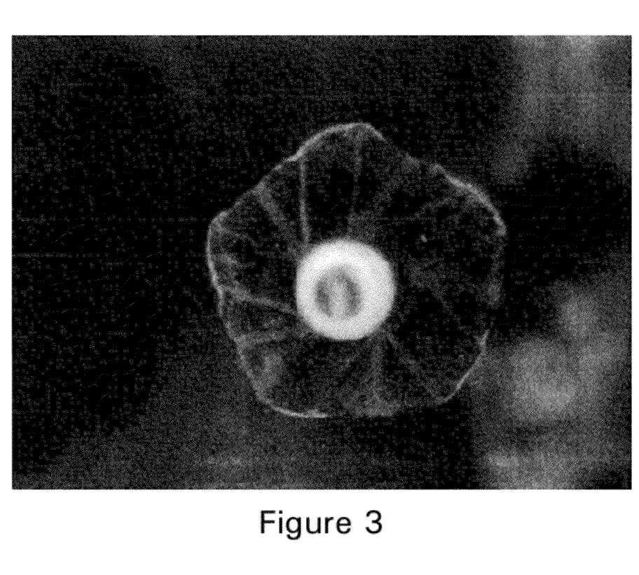

As discussed above, and illustrated in FIG. 3, conventional techniques for coating and folding of an expandable member require the expandable member be coated in the fully expanded configuration and thereafter dried in this same fully expanded configuration. Consequently, upon refolding the expandable member, the dried and brittle coating is often damaged and/or displaced due to the compressive forces exerted on the brittle and inflexible coating during the refolding process. This damage and/or loss of coating on the expandable member thereby compromises the efficacy of the medical device.

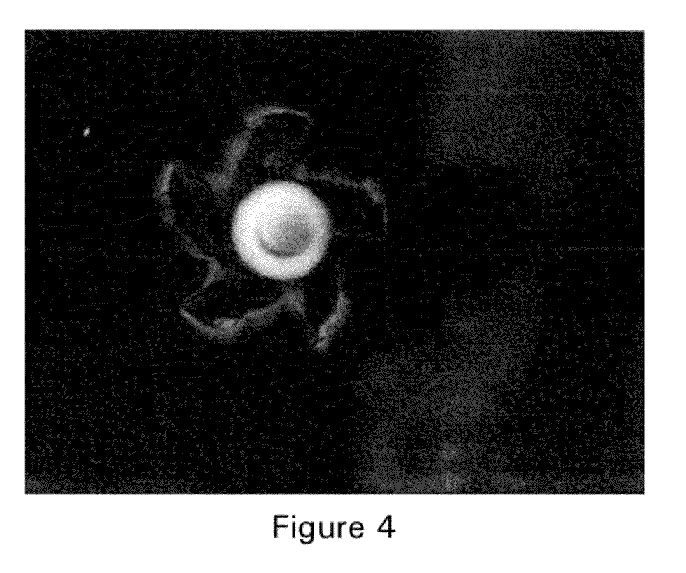

Therefore, and in accordance with an aspect of the disclosed subject matter, the coating applied to the external surface of the expandable member is allowed to dry while the expandable member is in the partially collapsed or folded configuration. As shown in FIG. 4, the initial amount of inflation medium is withdrawn after the coating is applied and is still in a malleable or free flowing, e.g. wet, state. The flexibility exhibited by the coating in this state allows for greater retention of the coating on the expandable member since the forces exerted on the coating during the initial or partial refolding can be absorbed or distributed within the coating layer. A drug dosage of about 10-600 μg/cm² and a coating thickness of about 1-40 μm are preferred. It is preferred that the viscosities of coating solutions are generally low, however, laminar flow at Reynold's numbers less than 2300 should be maintained for uniform coating and to maintain a continuous stream by direct fluid application.

Upon releasing the initial amount of inflation medium to achieve the intermediate pressure, thereby partially deflating and refolding the expandable member, the expandable member can be exposed to a drying environment to evaporate a solvent contained within the coating solution. The drying environment can include an oven configured to receive the entire expandable member and apply a heat to the entire surface area of the expandable member and coating applied thereto. As discussed above, a mandrel can be inserted into the guidewire lumen 22 of the catheter. The mandrel serves to inhibit or prevent bowing or warping of the catheter and expandable member. Accordingly, the expandable member is maintained in a consistent and linear alignment about the longitudinal axis of the catheter, which in turn allows the therapeutic agent to dry in a consistent and uniform fashion on the surface of the expandable member, thus maximizing the efficacy of the therapeutic agent. The mandrel can be configured with a length to extend at least the length of the expandable member, and an outer diameter for positioning within the guidewire lumen 22. The drying temperature and dwell time will vary depending upon the solvent formulation used, the maximum temperature being limited by drug presence on the expandable member. A temperature of 50° C. and dwell time of 1 hour is preferable for acetone/ethanol solvent evaporation. The preferred ranges for temperature and dwell time are 30°-60° C. and 5 minutes to 2 hours, respectively. Pressure is also to be considered for solvent evaporation and coating drying. For example, some slow evaporating solvents would require a vacuum of approximately 25 inHg and 30°-60° C. drying temperature for multiple hours. Additionally, or alternatively, a plurality of nozzles can be arranged to impart a controlled stream of air to select portions of the expandable member. This allows for non-uniform or patterned drying of the coating such that, for example, a middle portion of the expandable member can be dried at a different rate, temperature or for a different period of time, than the end portions of the expandable member, if so desired. The drying nozzles can employ air at ambient conditions, or alternatively include a heat source to provide air at elevated temperatures.

In further accordance with the disclosed subject matter, the drying operation can be performed in a sequential or temporal order with respect to the coating, e.g. after the coating process has been completed. Alternatively, the drying operation can be performed simultaneously, as well as intermittently, with the coating process. Similarly, additional coating processes, and/or release of the inflation medium, can be performed after a drying operation, if so desired.

In accordance with another aspect of the disclosed subject matter, the coated expandable member can be exposed to an environment that facilitates plasticizing the coating. The plasticizing environment can include a relative humidity or solvent vapor atmosphere, as so desired. The preferred plasticizing environment has a temperature in the range of from about 20° to about 110° C., a solvent vapor pressure in the range of from about 10 torr to about 1520 torr. Preferably the environment would expose the coated expandable member to fluid in a gaseous, vapor, or liquid state, the preferred fluids being acetone, MEK, water, methanol, ethanol, isopropyl alcohol, diethyl ether, tetrahydrofuran, ethyl acetate. Volatile solvent has a vapor pressure at ambient temperature of at least about 0.6 torr. Preferably, exposure of the coated expandable member to such an environment occurs immediately after the coating process and prior to release of the initial amount of inflation medium to partially deflate/refold the expandable member; the duration of treatment being between approximately 1-60 minutes.

Further in accordance with the disclosed subject matter, the remaining or residual amount of inflation medium, i.e, intermediate pressure, can be withdrawn to completely deflate the expandable member. For example, and as embodied herein, an indeflator or vacuum box is provided to draw a vacuum on the expandable member. The indeflator or vacuum box is placed in fluid communication with the inflation lumen of the expandable member, after partial deflation of the expandable member to achieve the intermediate pressure by releasing an initial amount of fluid medium, the remaining or residual fluid/pressure within the expandable member is withdrawn to return the expandable member to the fully folded configuration. A mechanical force may be applied to the expandable member in combination with the vacuum to uniformly depress the folds. Application of the mechanical force may be required depending upon the material of the expandable member and its memory. As an example, the mechanical force may be applied by a hand-crimper.

In some embodiments a sheath can be placed over the expandable member. In such embodiments, one end of the sheath can be flared, in order to facilitate insertion of the expandable member therein and avoid any undesired snagging, and placed over the distal end of the expandable member. Additionally, a lubricious coating can be applied to reduce the frictional forces, provided the lubrication employed does not interfere or compromise the efficacy of the therapeutic agent. The sheath is slid over the expandable member a desired distance, until significant resistance is felt. Once the sheath is in the desired position, the stopcock is opened to the vacuum source, e.g. indeflator and a full vacuum is pulled to remove all residual fluid in the expandable member. The remainder of the sheath can then be advanced over the expandable member to ensure that no wrinkles or unwanted folds are present. In another embodiment the sheath may be applied after the vacuum compresses the expandable member.

In accordance with in the disclosed subject matter, an endoprosthesis, e.g. stent, can be mounted on the expandable member. The type of stent that can be used includes, but is not limited to, bare metal stent, drug eluting stent, prohealing stent, and self-expanding vulnerable plaque implant. The stent coating can contain the same or different therapeutic agents from the catheter or expandable member. Similarly, the coating on the catheter or expandable member can have the same or distinct release kinetics from the therapeutic coating on the stent. The coating applied to the expandable member can be allowed to dry prior to placement of the stent thereon. The stent may be used to provide a sustained release of drug.

Alternatively, the coating could not be allowed to dry or cure past a “tacky” state before the stent is positioned and/or crimped onto it. This would enable the adhesion of the coating on the expandable member to the inside of the prosthesis. This process increases the retention of the prosthesis onto the expandable member (acting as a prosthesis retention enhancer) thus reducing the chance that the stent will move on the expandable member during the torturous delivery through the vascular lumen.

If desired, and as previously discussed, a protective sheath can be provided to protect the coating during shipping and storage and/or during delivery of the coated expandable member through the body lumen. A variety of sheaths are known, including removable sheaths or balloon covers, retractable sheaths to be withdrawn prior to deployment of the balloon, and elastic sheaths that conform to the balloon upon expansion. Such elastic sheaths are porous or include apertures along a portion thereof In operation, the inflation of the expandable member causes the sheath to expand for release of the coating and/or therapeutic agent through the porous wall or apertures to the tissue of the arterial wall. For example, see U.S. Pat. No. 5,370,614 to Amundson, the disclosure of which is incorporated by reference in its entirety

While the disclosed subject matter is described herein in terms of certain preferred or exemplary embodiments, those skilled in the art will recognize that various modifications and improvements can be made to the disclosed subject matter without departing from the scope thereof Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method of coating an expandable member comprising:
providing an expandable member having a deflated configuration and a fully expanded configuration at a nominal pressure;
inflating the expandable member to an initial inflation pressure of from about 10% to about 300% of the nominal pressure;
disposing a therapeutic agent on at least a portion of the expandable member at the initial inflation pressure; and
partially deflating the expandable member to an intermediate pressure of from about 1% to about 100% of the nominal pressure; and
drying the therapeutic agent on the expandable member.

2. The method of claim 1, wherein the intermediate pressure is from about 10% to about 50% of initial inflation pressure.

3. The method of claim 1, wherein the initial inflation pressure inflates the expandable member to less than the fully expanded configuration.

4. The method of claim 1, wherein the therapeutic agent includes a mixture of at least one excipient and at least one solvent.

5. The method of claim 4, wherein drying includes heating of the expandable member to remove the solvent.

6. The method of claim 1, wherein pressure can be varied to control the rate of inflation or deflation of the expandable member.

7. The method of claim 1, further comprising after partially deflating the expandable member withdrawing a remaining pressure of from about 1% to about 100% of nominal pressure by drawing a vacuum on the expandable member.

8. The method of claim 1, wherein drying includes exposing the expandable member to an air stream of variable temperature and flow rate.

9. The method of claim 1, further comprising exposing the therapeutic agent to a plasticizing atmosphere when the expandable member is in the inflated condition.

10. The method of claim 1, wherein disposing the therapeutic agent is by spraying, dipping, syringe coating, electrospinning, electrostatic coating, direct fluid coating, or a combination thereof.

11. The method of claim 1, wherein the expandable member includes a plurality of folds defined therein, and having a folded configuration when deflated.

12. The method of claim 1, wherein the nominal pressure is supplied at a pressure of about 6 to about 12 atmospheres.

13. The method of claim 1, wherein deflating the expandable member to an intermediate pressure includes applying a negative pressure.

14. The method of claim 1, wherein deflating the expandable member to an intermediate pressure includes exposing the expandable member to ambient conditions.

15. The method of claim 1, further comprising disposing a mandrel within a lumen of the expandable member.

16. A system for coating an expandable member, the system comprising:
an inflator to inflate an expandable member to an initial inflation pressure of from about 10% to about 300% of nominal pressure;
a dispenser to dispose a therapeutic agent on at least a portion of an expandable member at the initial inflation pressure;
a deflation station to partially deflate an expandable member to an intermediate pressure of from about 1% to about 100% of nominal pressure; and
a drying station to dry the therapeutic agent on the expandable member.

17. The system of claim 16, wherein the initial inflation pressure inflates the expandable member to less than its fully expanded configuration.

18. The system of claim 16, wherein the drying station includes exposing the expandable member to an air stream of variable temperature and flow rate to remove a solvent from the expandable member.

19. The system of claim 16, wherein the deflation station exposes the expandable member to ambient conditions to deflate the expandable member to an intermediate pressure.

20. The system of claim 16, further comprising a vacuum in communication with the expandable member, the vacuum withdrawing a remaining pressure of from about 1% to about 100% of nominal pressure of the expandable member.

21. The system of claim 16, wherein the intermediate pressure is from about 10% to about 50% of initial inflation pressure.

22. The system of claim 16, further comprising a mandrel disposed within a lumen of the expandable member.
